(19) United States
(12) Patent Application Publication
(10) Pub. No.: US 2022/0064026 A1
(43) Pub. Date: Mar. 3, 2022

(54) Modular Personal Water Purifier

(71) Applicant: Aqua Research LLC, Albuquerque, NM (US)

(72) Inventors: Rodney E Herrington, Albuquerque, NM (US); Kevin Roderick, Albuquerque, NM (US)

(21) Appl. No.: 16/610,079

(22) PCT Filed: May 6, 2018
(86) PCT No.: PCT/US18/31285

§ 371 Date: Nov. 1, 2019

Related U.S. Application Data
(60) Provisional application No. 62/502,760, filed on May 7, 2017.

(51) Int. Cl. C02F 1/467; C02F 1/00; C02F 1/461

(52) U.S. Cl. CPC C02F 1/4674; C02F 1/002; C02F 2303/04; C02F 2201/009; C02F 1/46104

(57) ABSTRACT

An electrolytic device and method for generating a disinfecting solution controlled by an electrical circuit. The electrical circuit preferably conditions the power received from the electrolytic device itself, or from a variety of power sources to measure and control the energy feeding the electrolytic cell chamber to produce an oxidant solution for disinfection. The electrical circuit can also have warning lights, volume indicators, timers, and other features to facilitate human interaction and ease of use. A multitude of separate devices can provide the power source, including but not limited to, a solar panel, a one-time use or rechargeable battery, a wall plug type of charger, a car battery, or any number of other devices that can provide power. Communications can also be electronic from a cell phone with a software application, and Bluetooth or other means of communication between to the electrolytic oxidant producing device and a controller and also controlled to or from a power source. The system can incorporate a water filter, to remove particulate material or microorganisms from the raw water source.

This application is related to PCT patent application No. PCT/US12/23063, entitled “Personal Water Purifier” which was filed on Jan. 30, 2012, the disclosure of which is incorporated herein by reference.

### TECHNICAL FIELD

The present invention relates to the field of personal water purification devices. More particularly, the invention can provide safe water, power, and light utilizing solar power and common salt as the only consumables.

### BACKGROUND ART

Effective water treatment generally comprises two processes: filtration and disinfection. The United States Environmental Protection Agency and the regulatory agencies of many countries require that drinking water meet limits for clarity, typically measured by the cloudiness of the water and measured as Nephelometric Turbidity Units (NTU), and also that the water have an active disinfectant all the way to the drinking water tap. The active disinfectant standard since disinfection began in 1908 is chlorine. Many programs and devices have been employed to treat water at the municipal level, as well as at the individual level. There are currently 1.2 billion people on the planet who do not have access to safe drinking water, most of whom are in low income settings. Many treatment strategies have been attempted in these low income settings, but they all suffer from the inability to be sustainable. They all require a consumable component that requires periodic replenishment by the user. Users in these low income settings typically do not have the economic resources to continue the treatment protocol due to the on-going cost and logistics to support the treatment protocol.

There is a need to provide improved and low cost point-of-use (POU) and point-of-entry (POE) water treatment systems that disinfect the water, can be integrated with a solar powered light and power source, and that are completely sustainable and do not require an on-going cost to operate other than common salt. This modular system will provide the basic utilities—a means to make water safe, and provide power and light for those in low income settings.

### DESCRIPTION OF INVENTION

Embodiments of the present invention provide a water purifier system comprising (a) a power generation system configured to produce electrical energy responsive to incident solar energy; (b) an energy storage system configured to store energy produced by the power generation device; (b) a lighting system configured to produce light from energy accessed from the energy storage device; (d) an electrolytic system configured to produce disinfectant using energy accessed from the energy storage device; and (e) a control system configured to accept input from a user and control the lighting device and the electrolytic system responsive to such input.

In some embodiments, the power generation system comprises a photovoltaic panel. In some embodiments, the energy storage system comprises a rechargeable battery, an ultracapacitor, or a combination thereof. In some embodiments, the system further comprises a power input port, configured to provide, from a source outside the system, electrical power storable by the energy storage system.

In some embodiments, the lighting system comprises one or more light emitting diodes.

In some embodiments, the system further comprises a water filtration device. In some embodiments, the water filtration device comprises an element capable of being placed in a first configuration wherein the element has a flat shape amenable to storage, and in a second configuration wherein the element defines a concave shape amenable to accepting and filtering water poured into the concave shape. In some embodiments, the water filtration device is suitable for a plurality of cleaning and reuse cycles.

In some embodiments, the electrolytic system is configured to produce a disinfectant using water and salt.

In some embodiments, the electrolytic system comprises an electrolytic cell chamber and a salt storage chamber.

In some embodiments, the control system is integrated with the energy storage system, and the electrolytic system is removably mounted with the energy storage system.

In some embodiments, the energy storage system comprises a battery in a mobile telephone, the control system comprises software executed by and controlling the mobile telephone, and further comprising a removable connection between the mobile telephone and the electrolytic system configured to provide energy from the mobile telephone to the electrolytic system and to control the operation of the electrolytic system.

### BRIEF DESCRIPTION OF DRAWINGS

The accompanying drawing, which is incorporated into and form a part of the specification, illustrate example embodiments of the present invention and, together with the description, serve to explain the principles of the invention. The drawings are only for the purpose of illustrating a preferred embodiment of the invention and are not to be construed as limiting the invention. In the drawings:

FIG. 1 is a view of an electrolytic disinfection device with separate devices that can be used to power the disinfecting device.

### MODES FOR CARRYING OUT THE INVENTION AND INDUSTRIAL APPLICABILITY

According to the World Health Organization, more than 5,000 children in the world die every day from water-borne diseases. More than 1.2 billion people do not have access to safe drinking water. Many grass roots level campaigns have been conducted by agencies such as the World Health Organization, the Pan American Health Organization, the Center for Disease Control and Prevention (CDC), UNICEF, US AID, many non-governmental organizations (NGOs), private non-profit organizations, and private industries to try and solve this problem. Most of the current schemes involve some form of treatment technology that includes a consumable component. These solutions include distribution of bleach such as the Safe Water Program by the CDC, filtration systems by various organizations that require replacement, distribution of sachets that contain flocculant aids and disinfectants (aka Pur® sachets), devices that utilize ultraviolet (UV) light as a disinfectant (which do not maintain a disinfectant residual), and various other schemes. One thing they all have in common is that they require a consumable component, and a logistics train to support continued use of the product. They typically require some continued recurring cost to the end user—end users who often cannot afford even the basic fundamentals in life. The present invention preferably does not require a significant consumable for continued use and instead uses common salt, which is considered universally available, and has a shelf life of 10 years or greater. Once a device, or system according to the present invention is distributed, continued use of the device does not require a new logistics train or consumables (other than common salt) and is accordingly highly sustainable in developing countries.

There exist many types of power sources for operation of such a disinfectant generating device. As an example, cell phones are typically recharged by a wall plug type charger. Many devices are emerging on the market that have a solar panel and battery combination that provide the power source for recharging cell phones or other devices. Many computers have USB power outlets that can provide power sources to charge external devices such as cell phones. Likewise there are devices today such as the Waka Waka solar panel and LED light system and the dLight systems. These systems can include a battery that is charged or re-charged from the solar panel, and the battery provides the power source for the LED light. These LED solar systems can replace hazardous kerosene for lighting, and at less expense than kerosene. Embodiments of the present invention can use such a power source to power an electrolytic cell device for producing a disinfecting solution from a halogen brine solution.

In a developing nation setting, many people are living at extreme poverty levels. Devices that they use to make their water safe must be available to them at a price that they can afford. It is incumbent on the manufacturer to produce a very low-cost disinfection device if the product is going to be market viable in the extreme poverty setting. As such, a device is needed that is stripped of all essentials to help reduce cost. Devices for people in third world settings should not be redundant in terms of components that can be shared with other systems. As realized in connection with some embodiments of the present invention, a disinfection device can be stripped of an on-board battery, solar panel, LED lights, and other components if these components are already parts of other devices or system that the user may already possess.

The MSR/MIOX Purifier has been commercialized since approximately 2003. This device is patented under U.S. Pat. No. 6,261,464 to Herrington, et al., entitled Portable Water Disinfection System. This device uses non-rechargeable batteries to electrolyze a salt water brine solution to convert the chloride to chlorine in an electrolysis process. While this device has had significant commercial sales, user feedback indicates that this device suffers from several shortcomings in the commercial marketplace, including: (1) battery replacement requirement, (2) chlorine taste, (3) wait time, (4) lack of particulate removal, (5) complexity of instructions, and (6) high price point.

Example embodiments of the present invention can address all of these shortcomings with new innovations, configurations, and operating parameters, and can be cost effective in a low income setting by avoiding components that are available in other devices on the market or already accessible by the user.

In an example embodiment, the device comprises an electrolytic cell with a circuit for measuring and controlling the amount of oxidant produced in order to ensure the proper disinfectant dose to the water being treated. The device can be configured to treat different volumes based on the water container volume the end user is using. In an example embodiment, the primary electrical power source for the electrolytic cell and controls can be a separate rechargeable battery or a battery that utilizes a solar panel as a means of recharging the battery. Additionally or alternatively, the electrolytic cell can be powered from an external power source via a USB port, as an example, a USB charger plugged into a wall outlet, or a computer with a USB charging port. The disinfecting device can be plugged directly in to the computer USB port, or can be connected via a cable to the computer.

In an example embodiment of the device, the electrolytic cell can be the only component in the separate electrolytic device. The control circuit for the electrolytic cell can be integrated in to the separate device providing the power. Further, the control circuit for the electrolytic cell can be integrated in to the same printed circuit board that controls the device providing the power. For instance, a device that has an LED light powered by a rechargeable battery and solar panel often has a circuit board, and that circuit board can incorporate the control circuit for the electrolytic cell in order to further minimize the number of components in the system.

In an example embodiment of the device, a cell phone or personal digital assistant (PDA) or computer can utilize a downloadable application to utilize either a tethered cable between the devices, or a wireless communication link (e.g., Bluetooth) between the devices to select the appropriate settings on the electrolytic device and activate the electrolytic device, as well as transmit pertinent operating parameters to the cell phone, PDA, or computer to display operating parameters of the electrolytic device such as power levels, electrolyte conductivity, or timing or warning features, among others.

In an example embodiment of the device, the personal purifier can also comprise a compact or folding filtration mechanism that is integral to the device, or additionally or alternately can be removed from the device when being used. Origami (the art of folding paper into complex shapes) techniques can be utilized to provide a folding filter that is in the shape of a cone or cup in a first configuration, and can be folded flat for storage in the device in a second configuration. A variety of filter materials can be suitable, as an example a filter material that adsorbs all of the microorganisms in the raw water, and also destroys all of the microorganism on contact with the filter media, can be suitable. The disinfection characteristics of the filter can also ensure that biofilm does not accumulate on the filter media during storage.

Note that the following discussion refers to a number of publications and references. Discussion of such publications herein is given for more complete background of the scientific principles and is not to be construed as an admission that such publications are prior art for patentability determination purposes.

Electrolytic technology utilizing dimensionally stable anodes (DSA) has been used for years for the production of chlorine and other mixed-oxidant solutions. Dimensionally stable anodes are described in U.S. Pat. No. 3,234,110 to Beer, entitled “Electrode and Method of Making Same,” whereby a noble metal coating is applied over a titanium substrate.

An example of an electrolytic cell with membranes is described in U.S. Patent RE 32,077 to deNora, et al., entitled “Electrode Cell with Membrane and Method for Making Same,” whereby a circular dimensionally stable anode is utilized with a membrane wrapped around the anode, and a cathode concentrically located around the anode/membrane assembly.

An electrolytic cell with dimensionally stable anodes without membranes is described in U.S. Pat. No. 4,761,208 to Gram, et al., entitled “Electrolytic Method and Cell for Sterilizing Water.”

Various commercial electrolytic cells that have been used routinely for oxidant production can utilize a flow-through configuration, pressurized or not, that is adequate to create flow through the electrolytic device. Examples of cells of this configuration are described in U.S. Pat. No. 6,309,523 to Prasnikar, et al., entitled “Electrode and Electrolytic Cell Containing Same,” and U.S. Pat. No. 5,385,711 to Baker, et al., entitled “Electrolytic Cell for Generating Sterilization Solutions Having Increased Ozone Content,” and many other membrane-type cells.

In other configurations, the oxidant is produced in an open-type cell or drawn into the cell with a syringe or pump-type device, such as described in U.S. Pat. No. 6,524,475 to Herrington, et al., entitled “Portable Water Disinfection System.” This device utilizes batteries and an internal circuit to measure electrical current being delivered to the electrolytic cell. Various electronic components and software in the electrical circuit alarm for low salt and low battery condition, and ensure that adequate power is provided to the electrolytic cell to ensure that the oxidant generated by the device has maximum disinfection efficacy.

U.S. Pat. No. 6,736,966 to Herrington, et al., entitled “Portable Water Disinfection System”, which is incorporated herein by reference, describes disinfection devices that utilize, in one instance, a cell chamber whereby hydrogen gas is generated during electrolysis of an electrolyte, and provides the driving force to expel oxidant from the cell chamber through restrictive check valve type devices. In this configuration, unconverted electrolyte is also expelled from the body of the cell as hydrogen gas is generated. In an alternate configuration in the same application, hydrogen gas pressure is contained in a cell chamber during electrolysis, but the pressure within the cell chamber is limited by the action of a spring loaded piston that continues to increase the volume of the cell chamber as gas volume increases. Ultimately, a valve mechanism opens, and the spring-loaded piston fills the complete volume of the cell chamber forcing the oxidant out of the cell chamber.

In electrolytic cells utilizing titanium substrates with noble metal coatings as the anode, the pH at the surface of the anode is typically low, on the order of approximately 3. With sufficiently high brine concentration in the electrolyte, and sufficiently low voltage potential at the anode surface, oxygen generated at the anode surface reacts to form hypochlorous acid and other chlor-oxygen compounds with no oxygen gas liberated. Typical cathodes in these electrolytic cells can comprise titanium, noble metal coated titanium, catalyst coated titanium, nickel based allows such as Hastalloy, stainless steel, and other conductive materials impervious to high pH conditions. At the cathode, hydrogen is liberated at the cathode surface with a localized high pH value at the cathode surface. During electrolysis, the metal comprising the cathode is not oxidized or otherwise damaged during electrolysis despite the production of hydrogen at the cathode surface. Over time, titanium hydride can form at the surface of a bare titanium cathode which can cause stress concentrations in the cathode surface. To preclude this hydride formation, noble metal or catalyst coatings can be applied to the cathode surface to prevent titanium hydride from forming on the cathode surface when the cathode substrate comprises titanium.

Alternately, anode and cathode electrodes can comprise boron doped nanocrystalline or ultra nanocrystalline diamond electrodes. See, e.g., U.S. Pat. No. 7,144,753 to Swain, et al, entitled Boron Doped Nanocrystalline Diamond describes electrodes for electrolysis. In an alternative embodiment, electrodes can be constructed of boron doped ultra nanocrystalline diamond. One advantage of diamond electrodes is the capability to carry much higher current densities than conventional dimensionally stable anodes (DSA) which facilitates smaller and lower cost anodes for the same chlorine production capacity as DSA anodes. Diamond electrodes are also able to sustain reverse polarity which is useful in decontaminating the electrodes.

An electrolytic disinfection device can utilize sodium chloride as a salt that is converted to brine and is electrolyzed to form sodium hypochlorite or chlorine based mixed oxidants as the disinfectant. Alternately, the device can use some other form of halogen to produce a disinfectant such as sodium hypochlorite, chlorine dioxide, bromine, or other such disinfectant that can be used for disinfection. In an example embodiment, the natural chlorides that are in most waters can be utilized to make chlorine for introduction to the water to be treated. The circuit to power the electrolytic cell can comprise a rechargeable battery and an electric circuit to measure power entering the electrolytic cell chamber and thereby converting chloride and water in the electrolyte to chlorine and oxygen based oxidant components. Said electrical circuit also can integrate over-voltage, under-voltage, over-current, and/or under-current protection circuits to ensure the device is not damaged during charging or discharging of electrical power. Said circuit also can ensure that electrical conditions at the electrolytic cell are adequate to produce oxidant that is effective for the purpose of disinfection.

A rechargeable battery can be recharged using a solar panel. The energy storage device can be a super capacitor, instead of or in addition to a rechargeable battery. The device can also optionally incorporate other devices such as light emitting diodes (LEDs) or light bulbs for light generation (to monitor operation in a dark setting) or signaling, electrical terminals for providing an electrical potential to heat a resistance circuit to generate heat or flame, a global positioning system (GPS) location identification device, an electronic compass, a radio device, an emergency beacon transponder, a cell phone, a digital clock, a camera, a voice or music recorder, a data storage device, or other such electronic components. The device can also be configured to utilize the separate solar panel or storage devices (battery or supercapacitors, as examples) to charge external devices such as cell phones, PDAs, or other devices that have rechargeable batteries. Control features can also include a tethered or wireless connection to a PDA with a downloadable application that can operate and monitor the features of the disinfection device.

In an example embodiment of the present invention, the device is sealed to prevent water intrusion to the inside of the device, and can include waterproofing of any external electrical connections to prevent damage from contact with water. The device can also incorporate a soft exterior band to protect the device from damage due to a drop to a solid surface such as concrete.

In an example embodiment of the present invention, for treating highly contaminated surface water or high turbidity source waters, the system comprises an on-board, or separable, filter to provide pre-filtration of the water to be disinfected. In an example embodiment, the filtration material can comprise a porous sheet to provide physical filtration of suspended particles or microorganisms. Additionally, the filter material can be prepared by incorporating a biocidal material or coating to minimize contamination of the filtration media.

In an example embodiment of the present invention, for treating highly contaminated surface water or high turbidity source waters, the system comprises an on-board (or separable) filter to provide pre-filtration of the water to be disinfected. U.S. Pat. No. 7,901,660 to Xie, et al, entitled “Quaternary oxides and catalysts containing quaternary oxides”, describes nitrogen doped titanium oxide nano-particles that are effective as disinfectants by producing hydroxyl radicals photochemically when exposed to a light source (including sunlight). By applying these materials to the appropriate substrate filter material, the filter material physically absorbs microorganisms in the filter material and the hydroxyl radicals generated by the doped titanium oxide material proceed to inactivate all of the microorganisms that have been captured by the fabric material. This is achieved without significant pressure loss by simply pouring water through the filter material.

In an example embodiment of the present invention, for treating highly contaminated surface water or high turbidity source waters, the system comprises an on-board, or separable, filter to provide pre-filtration of the water to be disinfected. A paper published Linnea Ista, et al., published in the American Chemical Society journal Applied Materials and Interfaces entitled “Conjugated-Polyelectrolyte-Grafted Cotton Fibers Act as ‘Micro Flypaper’ for the Removal and Destruction of Bacteria”, describes conjugated polyelectrolytes (CPE) that are bonded to a fabric substrate which becomes effective as disinfectant by producing singlet oxygen when exposed to visible light. By applying the CPE to the appropriate substrate filter material, the filter material adsorbs the microorganisms and the light induced singlet oxygen proceeds to inactivate all of the microorganisms that have been captured by the fabric material. This is achieved without significant pressure loss in the filter material.

In order to provide compact storage, yet a useful shape (e.g., cup-shape) for filtering source water, an example embodiment of the present invention incorporates origami folding techniques to implement an appropriate filter that can be repeatedly folded and unfolded for use or storage in a compact configuration.

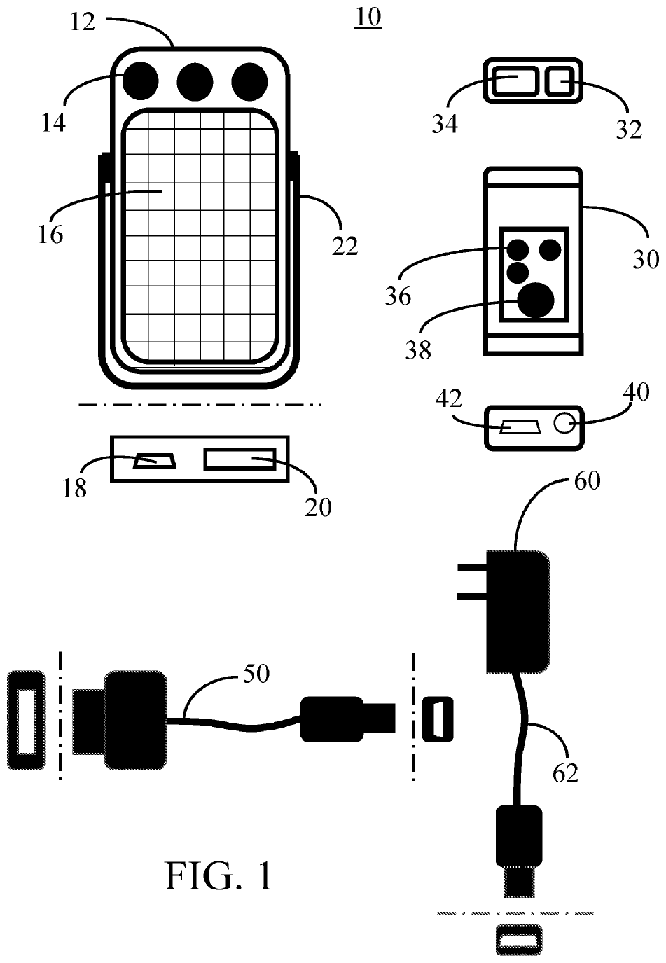

With reference to FIG. 1, electrolytic cell device 30 comprises electrolytic cell chamber 32 and salt storage chamber 34. Electrolytic cell device 30 may incorporate a control circuit within electrolytic cell device 30, or the control circuit may be incorporated in power source 12. Electrolytic cell device 30 may also incorporate high intensity light or LED 40 which is activated by activation button 38. Electrolytic cell device 30 may also incorporate a charging port such as a micro USB port 42. Electrolytic cell device 30 may incorporate activation button 38, or activation button 38 may be incorporated in power source 12. Power source 12 may comprise a rechargeable or non-rechargeable battery or other energy storage device, and can incorporate solar panel 16. Power source 12 may also incorporate power outlet port 20, power inlet port 18, and LED lights 14. To more correctly align power source 12 to the sun, power source 12 may incorporate a movable stand 22. In an alternate embodiment, power may be provided by wall plug charger 60. Wall plug charger 60 may incorporate any length cable 62 with the appropriate connector on the end to power electrolytic cell device 30. Connections between power source 12 and electrolytic cell device 30 can be provided by electrical cable 50.

Other objects, advantages and novel features, and further scope of applicability of the present invention will be set forth in part in the detailed description to follow, taken in conjunction with the accompanying drawings, and in part will become apparent to those skilled in the art upon examination of the following, or can be learned by practice of the invention. The objects and advantages of the invention can be realized and attained by means of the instrumentalities and combinations particularly pointed out in the appended claims.

1. An unpowered oxidant production system comprising: (a) a power input port configured to connect with and accept electrical energy from a standard power communication plug; (b) an electrolytic system configured to produce disinfectant using energy accessed from the power input port; and (c) a control system configured to accept input from a user and control the electrolytic system responsive to such input to produce oxidant.

2. An unpowered oxidant production system as in claim 1, wherein the power input port comprises a USB port.

3. (canceled)

4. (canceled)

5. (canceled)

6. (canceled)

7. An unpowered oxidant production system as in claim 1, further comprising a water filtration device, wherein the water filtration device comprises an element capable of being placed in a first configuration wherein the element has a flat shape amenable to storage, and in a second configuration wherein the element defines a concave shape amenable to accepting and filtering water poured into the concave shape.

8. An unpowered oxidant production system as in claim 1, wherein the electrolytic system is configured to produce a disinfectant using water and salt.

9. An unpowered oxidant production system as in claim 1, wherein the electrolytic system comprises an electrolytic cell chamber and a salt storage chamber.

10. (canceled)

11. (canceled)

12. (canceled)

13. An unpowered oxidant production system as in claim 1, wherein the system has no electrical energy production system.

14. An unpowered oxidant production system as in claim 1, wherein the system has no electrical energy storage system.

15. An unpowered oxidant production system as in claim 13, wherein the system has no electrical energy production system.
